(19) United States
(12) Patent Application Publication
(10) Pub. No.: US 2004/0139391 A1
(43) Pub. Date: Jul. 15, 2004

(54) Integration of handwritten annotations into an electronic original

(75) Inventors: William K. Stumbo, Fairport, NY (US); Nathaniel G. Martin, Rochester, NY (US)

Correspondence Address: Mark S. Svat, Fay, Sharpe, Fagan, Minnich & McKee, LLP, Seventh Floor, 1100 Superior Avenue, Cleveland, OH, 44114-2579, US

(73) Assignee: XEROX CORPORATION

(21) Appl. No.: 10/342,641

(22) Filed: Jan. 15, 2003

(51) Int. Cl. G06F 15/00

(52) U.S. Cl. 715/512; 715/541

(57) ABSTRACT

An author of a document creates an electronic original (28) of the document in a word processor. The author prints (14) a hard copy (32) of the electronic original (28). An editor makes manual changes (36) to the hard copy (32), then scans it with a scanner, (40) creating a marked-up electronic copy (42). The marked-up electronic copy (42) and the electronic original (28) are compared, the original being subtracted from the marked-up copy creating a difference copy (48). The differences are assumed to be annotations, grouped, and inserted into the original document (28) as markers. The author can select the markers to make pictures of the annotations appear to aid in electronic editing.

### BACKGROUND OF THE INVENTION

The present invention relates to the text imaging arts. It finds particular application in conjunction with incorporating hand-written annotations into an electronic document, and will be described with particular reference thereto. However, it is to be appreciated that the present invention is also amenable to other like applications. For example, one might make notes on a paper copy of slides presented at a meeting and collect those hand written notes by extracting the underlying slide images. As another example, people might extract hand written information from a paper copy of an electronic form.

When editing an electronic document, the editor, simply stated, has two options. These options include editing the electronic copy directly, or printing a hard copy, making hand-written mark-up corrections to the hard copy, and changing the electronic copy later. The latter option is in most cases, preferable over the former. Briefly summarized, some of the reasons that people prefer marking-up a hard copy to marking-up an electronic copy follow. Physical cues on the paper give people a better sense of text. The layout of information changes on electronic documents as marks are added. The three dimensional nature of paper helps people organize and structure their work. Paper allows free form marking. Annotations on paper capture a history of interactions. Multiple editors can interact and communicate through written annotations. Lastly, hard copies require no presentation device, such as computers, PDAs, cellular phones, etc. For these and other reasons, marking-up a document from a hard copy is preferred over marking-up an electronic document.

While marking-up a hard copy does provide these advantages, it is often tedious and time consuming to try to associate the indicated changes with the electronic document. The document author must repeatedly reference the hard copy, which has the markings, and manually associate the marking with the unmarked electronic copy.

The present invention contemplates a new and improved annotation incorporation method and apparatus, which overcomes the above-referenced problems and others.

### BRIEF DESCRIPTION OF THE INVENTION

In accordance with one aspect of the present invention, a method of integrating hand written annotations into an original electronic document is provided. An original electronic document is created with a word processor. A hard copy is printed and edited manually. The marked-up hard copy is scanned, producing a marked-up electronic copy. The marked-up electronic copy and the original are associated. Markers are inserted into the original electronic document indicating the manual changes.

In accordance with another aspect of the present invention, a document editing system is provided. A creating means, such as a word processor, creates an electronic original document. An output means, such as a printer, produces a hard copy of the original. An accepting means, such as a scanner, accepts a marked-up hard copy and renders a marked up electronic document. A comparing means compares the marked-up electronic copy and the electronic original. An indicating means indicates differences between the electronic original and the marked-up electronic copy.

According to another aspect of the present invention, a method of document comparison is given. An electronic original is compared to a marked-up electronic copy of the original. Any information not found on the electronic original is extracted from the marked-up electronic copy. This additional information is grouped into individual annotations. Each annotation is associated with a spatial position. The annotations are included in the electronic original.

According to another aspect of the present invention, a method of integrating hand written annotations into an original electronic document is provided. An original electronic document is created with a word processor. A hard copy is printed and marked-up manually. The marked-up hard copy is scanned, producing a marked-up electronic copy that includes the manual changes. The marked-up electronic copy and the original are associated. The association may include one of pixel-by-pixel comparison and optical character recognition (OCR). Pixel by pixel comparisons can be made on raster documents, perhaps generated for a printer from an editable file. OCR comparisons can be made on character-based documents such as an ASCII file. Markers are inserted into the original electronic document indicating the manual changes. The original is edited in accordance with the markers. The mark-ups are removed from the original document.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a flow diagram illustrating an exemplary process in accordance with the present invention;

FIG. 2 is a flow diagram that illustrates in more detail the process of FIG. 1;

FIG. 3 is a flow diagram that illustrates a comparison step in accordance with the present invention;

FIG. 4 illustrates a grouping and locating action of a locator in accordance with the present invention;

FIG. 5 illustrates a conversion of annotations into viewable tabs in a display in accordance with the present invention.

### DETAILED DESCRIPTION OF THE INVENTION

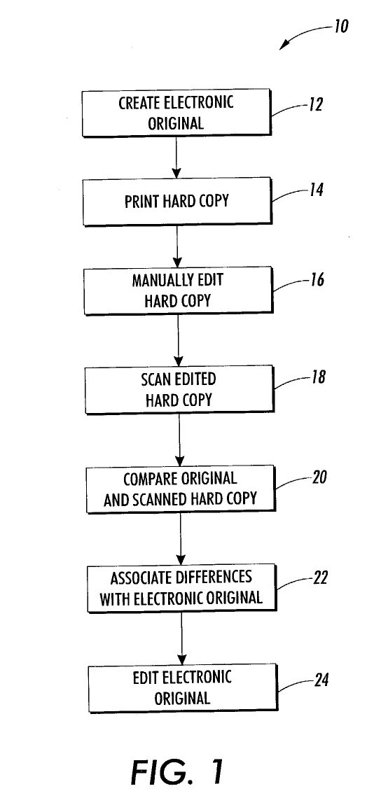

With reference to FIG. 1, it is a process flow diagram 10 for the generation of a marked-up electronic document according to the concepts of the present application.

Initially, an original electronic document is created 12 through the use of an electronic original creating means.

hI one embodiment, a word processor based on a personal computer platform is used to create the electronic original. Microsoft® Word® is an exemplary word processor for use in conjunction with the present invention. When an author has completed a draft of the electronic original, the author prints the document in a step 14 with a printer or other hard copy rendering output means. Although a printer is one type of rendering output means, it is to be understood that the electronic document may be rendered in a hard copy by other means, such as a personal digital assistant, (PDA) portable document format (PDF) writer, photo shop image, and the like.

The author or party, which has been given the original electronic document by the author, will manually edit the hard copy. In particular, the person editing the document will have pages of paper on which they will use either pencil or pen to make edits to the document in a well-known fashion. Once the manual editing of the hard copy has been completed, this marked-up version, having both printed text and hand written text is scanned to create a scanned marked-up electronic copy 18.

At this point there exist the electronic original in step 12, and the scanned marked-up electronic copy generated in step 18. Next, a comparison step 20 compares the original and the scanned electronic copy to determine differences between the two versions. The differences will be the hand written edited notes made by the author or other user. The differences are added into the electronic original in step 22. The differences that are added may be supplied in different formats, showing the edited changes in full-blown text, or as icons representative of the hand written changes. Thereafter, in a step 24 the user may view the images while editing the original document.

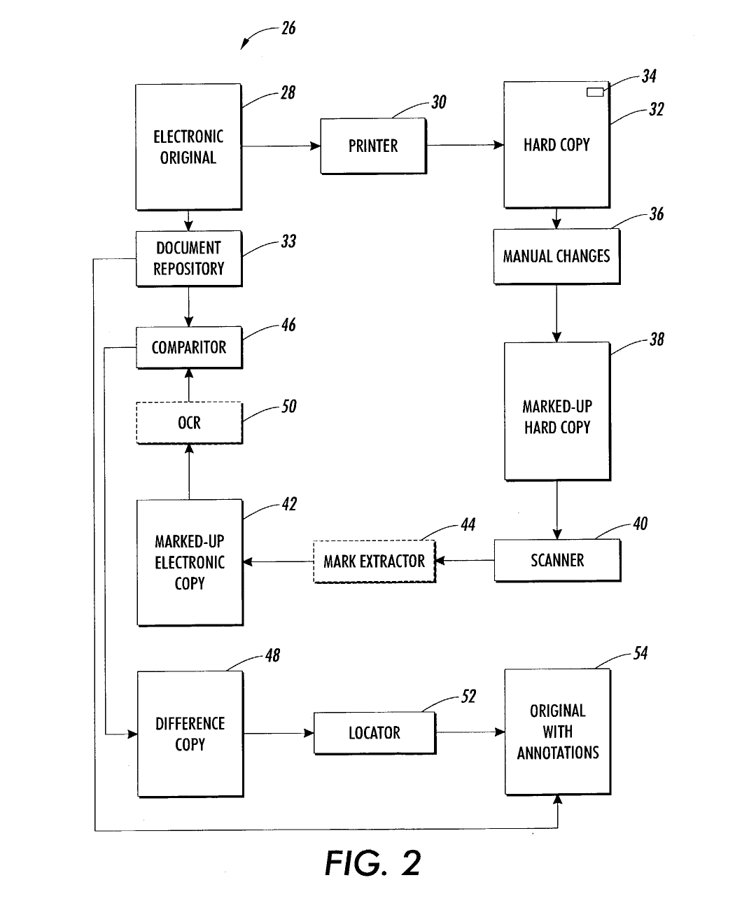

Turning to FIG. 2, and with continuing reference to FIG. 1, the general process described in FIG. 1 is expanded upon to provide greater detail as to the operations taking place within the process flow diagram 10 of FIG. 1.

In particular, in the operational flow 26 of FIG. 2, an electronic original 28 created by electronic generation step 12 of FIG. 1, is printed by a printer 30 into a hard copy format 32.

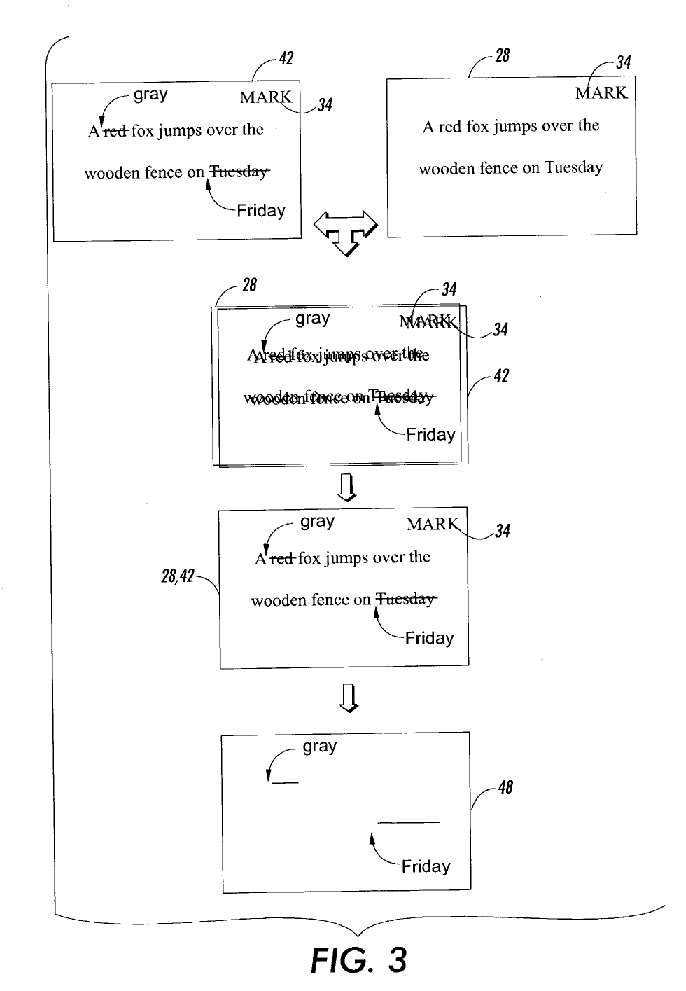

In the present embodiment, the electronic original used to create the hard copy document 32 that was printed is placed in a document repository 33, or other means for storing the electronic original, from where it is later withdrawn to be associated with later versions of the document. The document repository 33 ensures that there will be a version available for future comparisons. The printing step 14 generates the printed version 32 with a machine readable mark 34, (best seen in FIG. 3) including but not limited to glyphs, (both encoded and non-encoded) barcodes, etc. that may be optically recognized later and associated with the version in the document repository 33. That is, the machine-readable mark 34 identifies the electronic original from other electronic originals that may also be stored in the repository (e.g. from different versions of the document). The machine-readable marks 34 may also vary according to page number, so that associating the document will be easier even if the pages are scanned out of order.

With continuing attention to FIGS. 1 and 2, an editor manually marks up the hard copy by making manual changes 36, producing a marked-up hard copy 38. This editing includes any changes that are made directly to the hard copy 32 outside of the word processor in which the electronic original 28 was created. One or more editors can edit the hard copy 32. The author of the document is also a potential editor of the document.

Once all of the desired marks have been made to the marked-up hard copy 38, it is processed by a means for accepting the hard copy. In the present embodiment, the marked-up hard copy 38 is scanned by a scanner 40 as in the scanning step 18 of FIG. 1, producing a marked-up electronic copy 42. It is to be understood that other means known in the art capable of rendering an electronic copy from a hard copy fall within the scope of the present invention. In the scanning operation the machine readable mark 34 is recognized, and the version to which the pending edited copy is to be compared is identified.

Alternately, in a case of multiple editors editing multiple hard copies, each hard copy is scanned, and the marks are extracted by a comment extractor 44 and condensed into a single marked-up electronic copy 42. In this embodiment, the annotations can be separated by color, a certain color corresponding with a certain group of annotations (e.g. a certain editor). The annotations can also be assigned different representation icons. Like the colors, the icons can be associated with a specific group of annotations or editor. Additionally, the date and time that the annotation was made can be associated with the icon or representation that is inserted in the document. More specifically, the associated date and time would be representative of when an editor scanned their marked-up hard copy and performed a comparison.

In the comparison step 20 of FIG. 1 the marked-up electronic copy 42 and the electronic original 28 are associated by a document comparison means 46. In the present embodiment, the electronic original 28 from the document repository 33 is rendered into an image format, such as a bitmap image or other appropriated format and compared with the scanned image of the marked-up electronic copy 42. The image representation of the electronic original 28 is aligned with the marked-up electronic copy 42 and subtracted from the marked-up electronic copy 42 bit by bit, creating a difference copy 48. That is, darkened or otherwise matching pixels that occur in both the marked-up electronic copy 42 and the image representation of the electronic original are removed from the marked-up electronic copy 42. The leftover pixels are the hand written annotations and are included in the difference copy 48. Image clean-up processing may be performed on the leftover pixels to remove spurious marks caused by streaking or speckle introduces into the scanning step.

In the present embodiment, and with attention to FIG. 3, the comparison means 46 uses the machine-readable mark 34 as a reference for alignment between the marked-up electronic copy 42 and the electronic original 28. As can be seen in FIG. 3, the comparitor 46 aligns the two images until the machine-readable marks 34 align. The image of the electronic original 28 is subtracted out, leaving only the annotations as the difference copy 48. Other methods of alignment may be used in conjunction with the present application. Particularly, edge alignment of the documents, may be an appropriate method of alignment in some instances. In other situations, alignment may be made by markings on the electronic document or scanned edited document other than the machine-readable marks 34. For instance, selected locations of the text themselves may be used for the alignment purposes.

Alternately, the marked-up electronic copy 42 is processed by an optical character recognition (OCR) system 50, the result of which is compared to the electronic original. This alternate comparison is performed on a character-by-character basis, rather than on a pixel-by-pixel basis. In this embodiment, the marked-up electronic copy 42 is run through an OCR program, the result of which is compared to the electronic original 28 itself within a word processor. Objects located by the OCR such as characters, text, or images not included in the electronic original 28 are assumed to be hand written annotations. The present OCR embodiment can also be applied to multiple editors, including the advantages of separating mark-ups made by different editors. It is to be assumed that the OCR algorithm is capable of recognizing objects other than text. Such objects include, but are not limited to, line art, such as in a Power Point presentation, printed images, and the like. For example, a person may make notes on printed copies of Power Point slides, and then compare them back to the electronic original slides, extracting their hand-written comments and saving them separately, or inserting them back into the original.

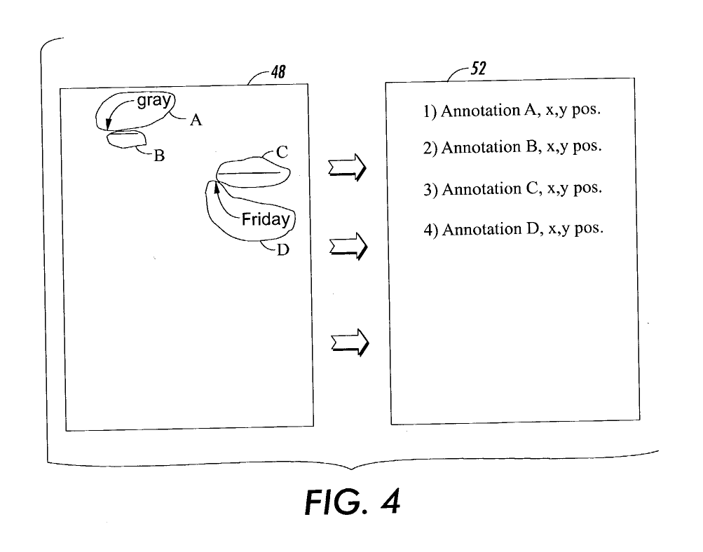

An annotation locator 52 groups and assigns spatial positions to the annotations that remain in the difference copy 48. In the present embodiment, and with reference to FIG. 4, and with continuing reference to FIGS. 1 and 2, markings of the difference copy are grouped according to their proximity to other markings. That is, any darkened pixels that are within a pre-determined distance of other darkened pixels are grouped together as a single annotation. As shown in FIG. 4, four separate annotations are grouped (A, B, C, D). In step 22, the locator 52 assigns each individual annotation a spatial position in the original document 28 based on the position of the annotation in the difference copy 48, and inserts the annotations into the electronic original. The author of the document can take the product of the adding step 22, that is, an annotated original 54, and edit this annotated original. When the author has made the desired changes, the annotations are removed from the document.

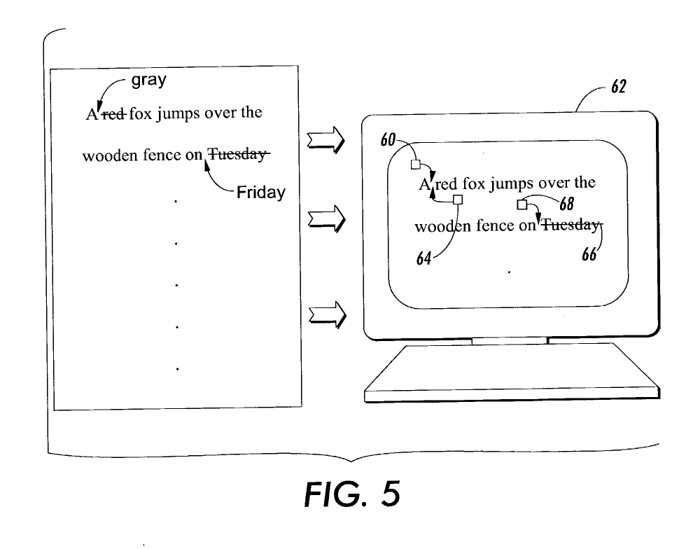

In the present embodiment, the annotations are stored as image files, references to which are inserted as markers into the original document 28. With reference to FIG. 5, the markers may be in the form of small tabs or flags at positions assigned by the locator 52. As shown in FIG. 5, the annotation that adds the word “gray” is represented as tab 60 on a human readable display 62. The line through the word “red” is assigned another tab 64 and displayed on the display 62. In another embodiment, easily electronically duplicated annotations are inserted directly into the display 62. The line through the word “Tuesday” is duplicated as a line 66 in the display 62. Easily duplicated annotations may be inserted in a color different than the color of the text of the electronic original 28. Such a color contrast helps the author identify easily duplicated annotations. In this embodiment, more complex annotations are still assigned tabs. The addition of the word “Friday” is assigned a tab 68 in the display 62. Preferably, when the author hovers the mouse pointer over, or otherwise selects one of these tabs, the image of the annotation itselfpops up in a display and the author can make the change as desired. In one embodiment, the pop up display is in a transparent .gif format so the author can still see what is behind the annotation while making a correction. It is to be understood that many other image formats that are known in the art are possible for the pop up annotations.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method of integrating hand written annotations into an original electronic document comprising:
creating an original electronic document;
printing a hard copy of the original electronic document, on which manual written changes are made;
scanning the hard copy with the manual changes and producing a marked-up electronic copy of the original document, including the manual changes;
associating the marked-up electronic copy with the original electronic document, the associating including one of comparing image representations of the original and the copy, and comparing recognizable objects of the original and the copy;
inserting markers in the original electronic document that correspond to the scanned manual changes, the inserted markers being positioned in the original to represent the manual changes in the hard copy.

2. The method as set forth in claim 1, further including:
editing the original electronic document using the mark-ups as guides.

3. The method as set forth in claim 1, further including:
removing the mark-ups from the original electronic document.

4. The method as set forth in claim 1, further including:
placing a version of the electronic original in a document repository, which step of placing ensues when the step of printing occurs.

5. The method as set forth in claim 4, wherein the step associating includes comparing the marked-up electronic copy with the version of the electronic original in the document repository.

6. The method as set forth in claim 5, further including:
indicating an electronic original from a plurality of electronic originals to compare to the marked-up electronic copy.

7. The method as set forth in claim 1, wherein the associating step includes:
comparing a converted representation of the marked-up electronic copy with the original electronic document.

8. The method as set forth in claim 7, wherein the associating step includes:
subtracting the original electronic document from the marked-up electronic copy producing an electronic difference copy.

9. The method as set forth in claim 8, wherein the step of associating includes:
grouping portions of the electronic difference copy; and,
assigning a spatial position to each grouped portion in the original electronic document.

10. The method as set forth in claim 9, wherein the inserting step includes:
inserting mark-ups that correspond to the assigned spatial positions.

11. The method as set forth in claim 10, further including:
displaying the mark-ups concurrently with the original electronic document;
displaying a grouped portion in response to the selection of its corresponding mark-ups.

12. A document editing system comprising:
a means for creating an electronic original document;
an output means for producing a hard copy of the electronic original;
a means for accepting a marked-up hard copy and rendering an electronic marked-up copy therefrom;
a means for comparing the marked-up electronic copy with the electronic original; and,
a means for indicating differences between the electronic original and the marked-up electronic copy in the electronic original, enabling a user to make changes to the electronic original based on the differences.

13. The document editing system as set forth in claim 12, further including:
a means for storing the electronic original until such a time when it is compared to the marked-up electronic copy.

14. The document editing system as set forth in claim 12, wherein the means for accepting a marked-up hard copy includes an optical scanner.

15. The document editing system as set forth in claim 12, wherein the means for comparing includes a bitmap comparitor that subtracts like bits between the marked-up electronic copy and the electronic original from the marked-up electronic copy.

16. The document editing system as set forth in claim 12, wherein the means for comparing includes an optical character recognition means.

17. A method of document comparison comprising:
comparing an electronic original to a marked-up electronic copy of the original, the marked-up electronic copy including information contained in the original, and additional information;
extracting the additional information from the marked-up electronic copy;
grouping the additional information into individual annotations;
associating each individual annotation with a spatial position; and,
including the annotations at their respective associated positions in the electronic original.

18. The method as set forth in claim 17, wherein the comparing step includes one of:
a character-by-character comparison between the original and the copy;
a pixel-by-pixel comparison between the original and the copy.

19. A method of integrating hand written annotations into an original electronic document comprising:
creating an original electronic document via a word processor;
printing a hard copy of the original electronic document, on which manual written changes are made;
scanning the hard copy with the manual changes and producing a marked-up electronic copy of the original document;
associating the marked-up electronic copy with the original electronic document;
inserting the mark-ups in the original electronic document at the locations that correspond to the scanned manual changes.

20. The method as set forth in claim 19, further including:
storing the manual changes within the original electronic document.

21. The method as set forth in claim 19, wherein the associating step includes extracting the manual written changes and saving them as a new electronic document
